(19) United States
(12) Patent Application Publication
(10) Pub. No.: US 2025/0246615 A1
(43) Pub. Date: Jul. 31, 2025

(54) POSITIVE ELECTRODE ACTIVE MATERIAL AND FLUORIDE ION SECONDARY BATTERY

(71) Applicant: HONDA MOTOR CO., LTD., Tokyo (JP)

(72) Inventor: Kazuyuki SATO, Saitama (JP)

(21) Appl. No.: 18/981,659

(22) Filed: Dec. 16, 2024

(30) Foreign Application Priority Data
Jan. 29, 2024 (JP) 2024-011292

(51) Int. Cl. H01M 4/48; H01M 4/02; H01M 10/36

(52) U.S. Cl. CPC H01M 4/483; H01M 10/36; H01M 2004/028

(57) ABSTRACT

Provided is a positive electrode active material for use in a fluoride ion secondary battery. The positive electrode active material includes Cu particles and Cu₂O particles. Provided is a fluoride ion secondary battery comprising a positive electrode material mixture layer comprising a positive electrode active material. The positive electrode active material includes Cu particles and Cu₂O particles.

This application is based on and claims the benefit of priority from Japanese Patent Application No. 2024-011292, filed on 29 Jan. 2024, the content of which is incorporated herein by reference.

### BACKGROUND OF THE INVENTION

### Field of the Invention

The present invention relates to a positive electrode active material for use in a fluoride ion secondary battery and a fluoride ion secondary battery.

### Related Art

In recent years, research and development has been conducted on secondary batteries that contribute to energy efficiency in order to ensure that many people have access to affordable, reliable, sustainable, and advanced energy.

Japanese Unexamined Patent Application, Publication No. 2018-73753 discloses a fluoride ion battery including at least a positive electrode active material layer and a solid electrolyte layer. The positive electrode active material layer includes positive electrode active material particles mainly containing Cu and Sn. The solid electrolyte layer includes a solid electrolyte containing Pb, Sn, and F.
Patent Document 1: Japanese Unexamined Patent Application, Publication No. 2018-73753

### SUMMARY OF THE INVENTION

However, with respect to the fluoride ion battery disclosed in Japanese Unexamined Patent Application, Publication No. 2018-73753, when the positive electrode active material layer expands and contracts with charge and discharge and the volume changes, the volume change is not easily absorbed, and as a result, the capacity retention ratio becomes low. Therefore, it is desired to achieve both an initial discharge capacity and a capacity retention ratio of the fluoride ion secondary battery.

An object of the present invention is to provide a positive electrode active material capable of achieving both an initial discharge capacity and a capacity retention ratio of a fluoride ion secondary battery.

A first aspect of the present invention is a positive electrode active material for use in a fluoride ion secondary battery. The positive electrode active material includes Cu particles and Cu₂O particles.

In a second aspect of the positive electrode active material according to the first aspect, a mass ratio of the Cu particles to the Cu₂O particles is 30/70 or more and 70/30 or less.

In a third aspect of the positive electrode active material according to the first or second aspect, the Cu particles and the Cu₂O particles are nanoparticles.

A fourth aspect of the present invention is a fluoride ion secondary battery including a positive electrode material mixture layer including the positive electrode active material according to any one of the first to third aspects.

According to the present invention, it is possible to provide a positive electrode active material capable of achieving both an initial discharge capacity and a capacity retention ratio of a fluoride ion secondary battery.

### DETAILED DESCRIPTION OF THE INVENTION

Hereinafter, an embodiment of the present invention will be described.

### [Positive Electrode Active Material]

The positive electrode active material of the present embodiment is for use in a fluoride ion secondary battery and includes Cu particles and Cu₂O particles. Therefore, both the initial discharge capacity and the capacity retention ratio of the fluoride ion secondary battery are achieved. It is assumed that this is because a complex of Cu particles and Cu₂O particles is formed at the time of manufacture of a powder composition for a positive electrode material mixture layer described later and/or at the time of charge and discharge of the fluoride ion secondary battery.

The mass ratio of the Cu particles to the Cu₂O particles in the positive electrode active material of the present embodiment is preferably 30/70 or more and 70/30 or less, and more preferably 40/60 or more and 60/40 or less. When the mass ratio of the Cu particles to the Cu₂O particles in the positive electrode active material of the present embodiment is 30/70 or more, the initial discharge capacity of the fluoride ion secondary battery increases, and when the mass ratio is 70/30 or less, the capacity retention ratio of the fluoride ion secondary battery increases.

The Cu particles and the Cu₂O particles are preferably nanoparticles. This increases the initial discharge capacity and the capacity retention ratio of the fluoride ion secondary battery. The particle sizes of the Cu particles and the Cu₂O particles are not limited, and are, for example, 10 nm or more and 100 nm or less.

### [Fluoride Ion Secondary Battery]

The fluoride ion secondary battery of the present embodiment includes a positive electrode material mixture layer including the positive electrode active material of the present embodiment. The fluoride ion secondary battery of the present embodiment further includes, for example, a positive electrode current collector foil, a solid electrolyte layer, a negative electrode material mixture layer, and a negative electrode current collector foil.

### (Positive Electrode Material Mixture Layer)

The positive electrode material mixture layer includes the positive electrode active material of the present embodiment, and may further include a solid electrolyte, a conductivity aid, and the like, if necessary. The positive electrode active material of the present embodiment may further include a positive electrode active material other than Cu particles and Cu₂O particles.

Examples of the positive electrode active material other than Cu particles and Cu₂O particles include, but are not limited to, Bi particles.

Examples of the positive electrode active material other than Cu particles, Cu₂O particles, and Bi particles include particles of a compound represented by the following general formula:

KₓBi₁₋ₓF₃₋₂ₓ
where x is 0.02 or more and 0.12 or less.

The positive electrode active material other than the Cu particles and the Cu₂O particles is preferably nanoparticles. The particle size of the positive electrode active material other than the Cu particles and the Cu₂O particles is, for example, 10 nm or more and 100 nm or less.

The solid electrolyte is not limited as long as it has fluoride ion conductivity and does not defluorinate during discharge of the fluoride ion secondary battery, and examples thereof include metal fluoride particles. Examples of the metal fluoride particles include Ce_{0.92}Sr_{0.08}F_{2.92} particles. The solid electrolyte is preferably nanoparticles. The particle size of the solid electrolyte is, for example, 10 nm or more and 100 nm or less.

The conductivity aid is not limited as long as it has electron conductivity, and examples thereof include acetylene black.

### (Positive Electrode Current Collector Foil)

The positive electrode current collector foil is not limited as long as it has electron conductivity, and examples thereof include metal foils such as gold foil and platinum foil.

### (Solid Electrolyte Layer)

The solid electrolyte constituting the solid electrolyte layer is not limited as long as it has fluoride ion conductivity and does not defluorinate during discharge of the fluoride ion secondary battery, and examples thereof include metal fluorides. Examples of the metal fluoride include Ce_{0.95}Sr_{0.05}F_{2.85}.

### (Negative Electrode Material Mixture Layer)

The negative electrode material mixture layer includes a negative electrode active material, and may further include a conductivity aid or the like as necessary. The negative electrode active material is not limited, and examples thereof include PbSnF₄ particles. The conductivity aid is not limited as long as it has electron conductivity, and examples thereof include acetylene black.

### (Negative Electrode Current Collector Foil)

The negative electrode current collector foil is not limited as long as it has electron conductivity, and examples thereof include metal foils such as aluminum foil.

The fluoride ion secondary battery of the present embodiment is obtained, for example, by sequentially laminating a positive electrode current collector foil, a powder composition for a positive electrode material mixture layer, a solid electrolyte layer, a powder composition for a negative electrode material mixture layer, and a negative electrode current collector foil, followed by press molding. Here, the powder composition for the positive electrode material mixture layer includes, for example, the positive electrode active material of the present embodiment, a solid electrolyte, and a conductivity aid. The powder composition for the negative electrode material mixture layer includes, for example, a negative electrode active material and a conductivity aid.

Although the embodiment of the present invention has been described above, the present invention is not limited to the above-described embodiment, and the above-described embodiment may be modified as appropriate within the scope of the gist of the present invention.

### EXAMPLES

Examples of the present invention will be described below, but the present invention is not limited to the examples.

(K_{0.06}Bi_{0.94}F_{2.88} Powder)

Potassium fluoride (manufactured by Kojundo Chemical Laboratory Co., Ltd.) and bismuth fluoride (manufactured by Kojundo Chemical Laboratory Co., Ltd.) were weighed and premixed for about 1 hour using an agate mortar and pestle to obtain a raw material mixed powder.

The obtained raw material mixed powder was classified using a stainless steel mesh having an opening of 500 μm. Next, the raw material mixed powder that did not pass through the mesh was mixed using an agate mortar and pestle and then classified, and this operation was repeated until all the raw material mixed powder passed through the mesh.

The weighing, pre-mixing, and classification of the raw materials were carried out in a purge-type (DBO type) glove box (manufactured by Miwa Manufacturing Co., Ltd.) to prevent fluoride from absorbing moisture.

The sealed powder hopper containing the raw material mixed powder after the classification was removed from the glove box and connected to a high frequency induction thermal plasma nanopowder synthesis system TP-40020NPS (manufactured by JEOL Ltd.). Next, argon gas was supplied to the plasma torch, the raw material mixed powder was melted with thermal plasma to form a raw material melt, and the raw material melt was sprayed into a chamber under reduced pressure. The raw material melt sprayed into the chamber was converted into nanoparticles through a cooling step to become K_{0.06}Bi_{0.94}F_{2.88} powder. Subsequently, the K_{0.06}Bi_{0.94}F_{2.88} powder was collected with an exhaust filter, and then the upstream and downstream sides of the exhaust filter were shut off with valves and transported into the glove box, where the K_{0.06}Bi_{0.94}F_{2.88} powder having a particle size of 10 nm or more and 100 nm or less was collected. Here, the composition of the K_{0.06}Bi_{0.94}F_{2.88} powder was analyzed by ICP emission spectrometry.

### (Cu Powder)

A Cu powder having a particle size of 10 nm or more and 100 nm or less was obtained in the same manner as in the case of the K_{0.06}Bi_{0.94}F_{2.88} powder, except that copper (manufactured by Kojundo Chemical Laboratory Co., Ltd.) was used instead of the raw material mixed powder.

### (Cu₂O Powder)

A Cu₂O powder having a particle size of 10 nm or more and 100 nm or less was obtained in the same manner as in the case of the K_{0.06}Bi_{0.94}F_{2.88} powder, except that cupric oxide (manufactured by Kojundo Chemical Laboratory Co., Ltd.) was used instead of the raw material mixed powder.

### (Powder Composition for Negative Electrode Material Mixture Layer)

Using a pot mill made of silicon nitride having a capacity of 45 mL and 10 balls made of silicon nitride each having a diameter of 10 mm, ball mill mixing of 6 g of lead fluoride (manufactured by Kojundo Chemical Laboratory Co., Ltd.) and 2.8 g of tin (II) fluoride (manufactured by Kojundo Chemical Laboratory Co., Ltd.) was performed. At this time, a cycle of performing ball mill mixing at 600 rpm for 3 hours followed by a 5-minute pause was implemented eight times. Next, 0.619 g of acetylene black was added to 8.669 g of the mixture, and ball mill mixing of the mixture was performed in the same manner as described above, followed by heat treatment at 400° C. for 1 hour in an argon atmosphere to obtain a powder composition for a negative electrode material mixture layer.

(Ce_{0.95}Sr_{0.05}F_{2.85} Powder)

Ball mill mixing of 19.3510 g of cerium fluoride (manufactured by Kojundo Chemical Laboratory Co., Ltd.) and 0.6490 g of strontium fluoride (manufactured by Kojundo Chemical Laboratory Co., Ltd.) was performed, followed by calcining at 1100° C. for 6 hours in an argon atmosphere to obtain a Ce_{0.95}Sr_{0.05}F_{2.85} powder. In ball mill mixing, a cycle of performing ball mill mixing at 600 rpm for 1 hour followed by a 5-minute pause was implemented 40 times.

### Comparative Example 1

### (Powder Composition for Positive Electrode Material Mixture Layer)

A powder composition for a positive electrode material mixture layer was prepared in a purge type (DBO type) glove box (manufactured by Miwa Manufacturing Co., Ltd.) filled with Ar gas. Specifically, 0.532 g of Cu powder, 0.178 g of Bi powder (manufactured by Kojundo Chemical Laboratory Co., Ltd.), and 0.267 g of K_{0.06}Bi_{0.94}F_{2.88} powder, as a positive electrode active material, and 0.023 g of acetylene black (manufactured by Denki Kagaku Kogyo Co., Ltd.), as a conductivity aid, were weighed. Next, using a pot mill made of silicon nitride having a capacity of 45 mL and 40 g of balls made of silicon nitride having a diameter of 2 mm, ball mill mixing of the weighed materials was performed in 8 g of cyclohexane, and then the mixture was dried on a hot plate at 65° C. to obtain a powder composition for a positive electrode material mixture layer. In ball mill mixing of the weighed materials, a cycle of performing ball mill mixing at 300 rpm for 15 minutes followed by a 5-minute pause was implemented 80 times.

### (Cell)

A cell was prepared by using an alumina tube having an inner diameter of 10 mm in a purge type (DBO type) glove box (manufactured by Miwa Manufacturing Co., Ltd.) filled with Ar gas. Specifically, first, 150 mg of Ce_{0.95}Sr_{0.05}F_{2.85} powder as a solid electrolyte was uniaxially pressed at a surface pressure of 740 MPa to obtain a solid electrolyte layer. Next, a Pt foil as a positive electrode current collector foil, 10 mg of a powder composition for a positive electrode material mixture layer, a solid electrolyte layer, 30 mg of a powder composition for a negative electrode material mixture layer, and an Al foil as a negative electrode current collector foil were sequentially laminated, and then uniaxially pressed at 700 MPa to obtain a cell. Next, the cell was enclosed in a sealed glass container under a confining pressure of about 340 MPa.

### Example 1

A cell was obtained in the same manner as in Comparative Example 1, except that 0.372 g of Cu powder and 0.160 g of Cu₂O powder were used instead of 0.532 g of Cu powder.

### Example 2

cell was obtained in the same manner as in Comparative Example 1, except that 0.266 g of Cu powder and 0.266 g of Cu₂O powder were used instead of 0.532 g of Cu powder.

### Example 3

A cell was obtained in the same manner as in Comparative Example 1, except that 0.160 g of Cu powder and 0.372 g of Cu₂O powder were used instead of 0.532 g of Cu powder.

### Comparative Example 2

A cell was obtained in the same manner as in Comparative Example 1, except that Cu₂O powder was used instead of Cu powder.

### [Discharge Capacity]

Using Potentio/Galvanostat SI1287/1255B (manufactured by Solartron), constant current charge-discharge tests were conducted on cells with the inside of the glass container depressurized by a vacuum pump and the glass container placed in a thermostatic chamber at a temperature of 140° C. Specifically, first, after a current of 0.393 mA was applied, a current of 0.039 mA was applied, and charging was performed until the voltage reached 1.5 V (vs. Pb/PbF₂). Next, after a current of 0.393 mA was applied, a current of 0.039 mA was applied, and discharging was performed until the voltage reached-0.5 V (vs. Pb/PbF₂). At this time, the above cycle was implemented 10 times to determine the discharge capacity.

### [Capacity Retention Ratio]

The ratio of the discharge capacity at the 10th cycle to the initial discharge capacity was determined and used as the capacity retention ratio.

Table 1 shows the evaluation results of the initial discharge capacity and the capacity retention ratio of the cells. The initial discharge capacity is a capacity per 1 g of the positive electrode material mixture layer.

TABLE 1

| | Mass | Initial Discharge | Capacity Retention |
|---|---|---|---|
| | Ratio | Capacity | Ratio |
| | (Cu/Cu₂O) | [mAhg⁻¹] | [%] |
| Example 1 | 70/30 | 409 | 83 |
| Example 2 | 50/50 | 384 | 92 |
| Example 3 | 30/70 | 370 | 97 |
| Comparative | 100/0 | 418 | 59 |
| Example 1 | | | |
| Comparative | 0/100 | 327 | 100 |
| Example 2 | | | |

It can be seen from Table 1 that the cells of Examples 1 to 3 achieve both the initial discharge capacity and the capacity retention ratio. In contrast, the cell of Comparative Example 1 has a low capacity retention ratio because the positive electrode active material does not include Cu₂O particles. The cell of Comparative Example 2 has a low initial discharge capacity because the positive electrode active material does not include Cu particles.

What is claimed is:

1. A positive electrode active material for use in a fluoride ion secondary battery, the positive electrode active material comprising
Cu particles and Cu₂O particles.

2. The positive electrode active material according to claim 1, wherein a mass ratio of the Cu particles to the Cu₂O particles is 30/70 or more and 70/30 or less.

3. The positive electrode active material according to claim 1, wherein the Cu particles and the Cu₂O particles are nanoparticles.

4. A fluoride ion secondary battery comprising a positive electrode material mixture layer comprising the positive electrode active material according to claim 1.
